(19) United States
(12) Patent Application Publication
(10) Pub. No.: US 2017/0260944 A1
(43) Pub. Date: Sep. 14, 2017

(54) UNIVERSAL INLINE FUEL PUMP

(71) Applicant: K&N Engineering, Inc., Riverside, CA (US)

(72) Inventor: Steve Williams, Beaumont, CA (US)

(73) Assignee: K&N Engineering, Inc., Riverside, CA (US)

(21) Appl. No.: 15/452,599

(22) Filed: Mar. 7, 2017

Related U.S. Application Data
(60) Provisional application No. 62/305,421, filed on Mar. 8, 2016.

(51) Int. Cl. F02M 37/08; F02M 65/00; F02M 37/22

(52) U.S. Cl. CPC F02M 37/08; F02M 37/22; F02M 65/007; F02M 2037/082

(57) ABSTRACT

An apparatus and a method are provided for an inline fuel pump for conveying liquid fuel from a fuel source to an intake of an internal combustion engine. The inline fuel pump operates with various fuels, such as gasoline, diesel, biodiesel, gasoline-ethanol blends, as well as commonly used fuel additives. The inline fuel pump comprises an inlet placed into fluid communication with the fuel source. An outlet of the inline fuel pump is placed into fluid communication with the intake. An electric motor coupled with an internal liquid pump convey liquid fuel from the inlet to the outlet. The electric motor and the internal liquid pump are housed within a sealed case configured to protect the electric motor and the liquid pump from an exterior environment. Power leads convey electrical power from an electrical system of the vehicle to the electric motor.

### CROSS-REFERENCE TO RELATED APPLICATIONS

This application claims the benefit of priority of U.S. Provisional Application No. 62/305,421, filed Mar. 8, 2016.

### FIELD

The field of the present disclosure generally relates to fluid pumping devices. More particularly, the field of the present disclosure relates to an apparatus and a method for an electric fuel pump that is compatible with a wide variety of makes and models of vehicles, and is flexible-fuel compatible, wear resistant, corrosion resistant, self-priming, and self-regulating.

### BACKGROUND

A fuel pump generally serves to convey liquid fuel from a fuel tank to an intake of an internal combustion engine. Most early fuel pumps were operated by way of direct mechanical communication with the engine, and thus were driven by the engine. Typically, a diaphragm within a mechanical fuel pump would create a suction so as to draw liquid fuel from the fuel tank and then create pressure to push the fuel to a carburetor. Over time, however, the diaphragm would degrade, or fail completely, due to a combination of operational wear and engine heat. Degradation of the diaphragm generally would cause drivability issues; or in the case of a complete pump failure, would leave the vehicle inoperable. Further, with the mechanical pump directly exposed to engine heat, during high temperatures the liquid fuel could vaporize within the fuel pump. Since the mechanical pump was incapable of moving vaporized fuel, the engine would be starved of fuel, a condition known as “vapor lock,” and the vehicle would be inoperable.

As fuel injection became increasingly popular, mechanical fuel pumps generally were replaced by electric fuel pumps due to higher fuel pressure requirements. As will be appreciated, an electric fuel pump has several advantages over a mechanical fuel pump. An electric fuel pump doesn't rely on engine speed to pump the fuel, and thus the electric fuel pump provides a steady fuel pressure throughout a fuel system. An electric fuel pump need not be bolted onto the engine, and thus the electric fuel pump is not directly exposed to high engine temperatures. Due to lower operating temperatures and a steady fuel pressure, a properly installed electric fuel pump virtually eliminates the possibility of vapor lock. Further, many electric fuel pumps have no diaphragm undergoing continual stress during engine operation, and thus electric fuel pumps generally are more reliable and exhibit greater longevity than mechanical fuel pumps.

What is needed, however, is a standalone electric fuel pump that is simple to install into a wide variety of makes and models of vehicles, and is flexible-fuel compatible, wear resistant, corrosion resistant, self-priming, and self-regulating.

### BRIEF DESCRIPTION OF THE DRAWINGS

The drawings refer to embodiments of the present disclosure in which:

FIG. 1A is a side plan view illustrating an exemplary embodiment of an inline fuel pump coupled with an exemplary fuel filter, according to the present disclosure;

FIG. 1B is a perspective view illustrating the exemplary fuel filter illustrated in FIG. 1A in accordance with the present disclosure;

FIG. 1C is a perspective view illustrating an exemplary embodiment of a male hose barb which may be coupled with the inline fuel pump illustrated in FIG. 1A, according to the present disclosure;

FIG. 2A is a side plan view illustrating an exemplary embodiment of an inline fuel pump coupled with an exemplary reusable fuel filter, according to the present disclosure;

FIG. 2B is a perspective view illustrating the exemplary reusable fuel filter illustrated in FIG. 2A in accordance with the present disclosure; and

FIG. 3 is a perspective view illustrating an exemplary embodiment of a reusable inline fuel filter in accordance with the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first pump,” may be made. However, the specific numeric reference should not be interpreted as a literal sequential order but rather interpreted that the “first pump” is different than a “second pump.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and a method for an inline fuel pump for conveying liquid fuel from a fuel source to an intake of an internal combustion engine. The inline fuel pump generally is configured to operate with various fuels, such as gasoline, diesel, biodiesel, gasoline-ethanol blends of up to at least 85% ethanol (E85), as well as one or more commonly used fuel additives, and the like. The inline fuel pump comprises an inlet configured to be placed into fluid communication with the fuel source. An outlet of the inline fuel pump is configured to be placed into fluid communication with the intake. An electric motor coupled with an internal liquid pump are configured to convey liquid fuel from the inlet to the outlet. An envelope comprising a sealed case is configured to protect the electric motor and the internal liquid pump from an exterior environment. The envelope further comprises a base configured for mounting the inline fuel pump onto a flat surface within a vehicle by way of mechanical fasteners. Preferably, the envelope is comprised of a corrosion resistant composite material that is sufficiently durable and temperature resistant so as to retain its configuration during installation and operation of the inlet fuel pump when coupled with the fuel system of the vehicle. Power leads are configured to convey electrical power from an electrical system of the vehicle to the electric motor.

In one embodiment, an inline fuel pump for conveying liquid fuel from a fuel source to an intake of an internal combustion engine is disclosed, comprising: an inlet configured to be placed into fluid communication with the fuel source; an outlet configured to be placed into fluid communication with the intake; an electric motor coupled with an internal liquid pump configured to convey liquid fuel from the inlet to the outlet; an envelope which houses the electric motor and the internal liquid pump; and at least two power leads configured to convey electrical power to the electric motor.

In one embodiment, the electric motor is brushless and combined with the internal liquid pump, the electric motor being configured to be powered by way of a 6V, 12V, or 24V vehicle electrical system. In another embodiment, the envelope comprises a sealed case configured to protect the electric motor and the internal liquid pump from an exterior environment. In yet another embodiment, the envelope comprises a base configured for mounting the inline fuel pump onto a flat surface within the vehicle by way of mechanical fasteners.

In one embodiment, the envelope is comprised of a corrosion resistant composite material is sufficiently durable and temperature resistant to retain its configuration during installation and operation of the inlet fuel pump when coupled with the fuel system of the vehicle. In another embodiment, the internal liquid pump is configured to operate with various fuels, such as gasoline, diesel, biodiesel, gasoline-ethanol blends of up to at least 85% ethanol (E85), as well as one or more commonly used fuel additives. In yet another embodiment, the inlet and the outlet both comprise suitably taper-threaded openings configured to receive any of various fittings suitable for connecting the inlet and the outlet to a fuel system of a vehicle.

In one embodiment, the inlet is configured to receive a fuel filter comprising a filter medium disposed within a rigid envelope, a threaded fitting configured to be received into the inlet, and a hose fitting configured to receive a fuel hose which is in fluid communication with the fuel source. In another embodiment, the filter medium is comprised of a material suitable for filtering particulate debris and contaminants from liquid fuel flowing from the hose fitting to the threaded fitting. In yet another embodiment, the inlet is configured to receive a reusable fuel filter comprising a filter medium within a glass cylinder which is sealed between a first end cap and a second end cap.

In one embodiment, the glass cylinder is configured to facilitate directly viewing particulate debris and contaminants that are entrapped by the filter medium. In another embodiment, the filter medium is comprised of a material suitable for filtering particulate debris and other contaminants from liquid fuel. In yet another embodiment, a threaded fitting longitudinally protrudes from the second end cap and is configured to be received into the inlet, and a hose fitting extending longitudinally from the first end cap is configured to receive a fuel hose in fluid communication with the fuel source. In one embodiment, a downstream hose fitting protrudes from the second end cap and is configured to receive a fuel hose.

In one embodiment, a method for cleaning a reusable fuel filter comprising a filter medium within a glass cylinder which is sealed between a first end cap and a second end cap is disclosed, comprising: removing a fuel hose from the first end cap; unscrewing the reusable fuel filter from an inlet of an inline fuel pump; gaining access to the filter medium by unscrewing the first end cap and the second end cap to release the glass cylinder from the reusable fuel filter; utilizing a solvent to remove a buildup of particulate from the filter medium; reinstalling the filter medium within the glass cylinder; tightening the first end cap and the second end cap so as to seal the filter medium within the reusable fuel filter; establishing fluid communication between the second end cap and the inlet of the inline fuel pump; and inserting the fuel hose onto the first end cap.

In one embodiment, inserting the fuel hose comprises pushing the fuel hose onto a hose fitting of the first end cap, the fuel hose routing liquid fuel from a fuel source to the reusable fuel filter. In another embodiment, establishing fluid communication comprises screwing a threaded fitting of the second end cap into the inlet of the inline fuel pump. In one embodiment, installing further comprises applying any of various sealants to the threads of the threaded fitting. In another embodiment, establishing fluid communication comprises screwing a threaded fitting of a male hose barb into the inlet of the inline fuel pump, inserting a first end of a fuel hose onto the male hose barb, and inserting a second end of the fuel hose onto a hose fitting of the second end cap.

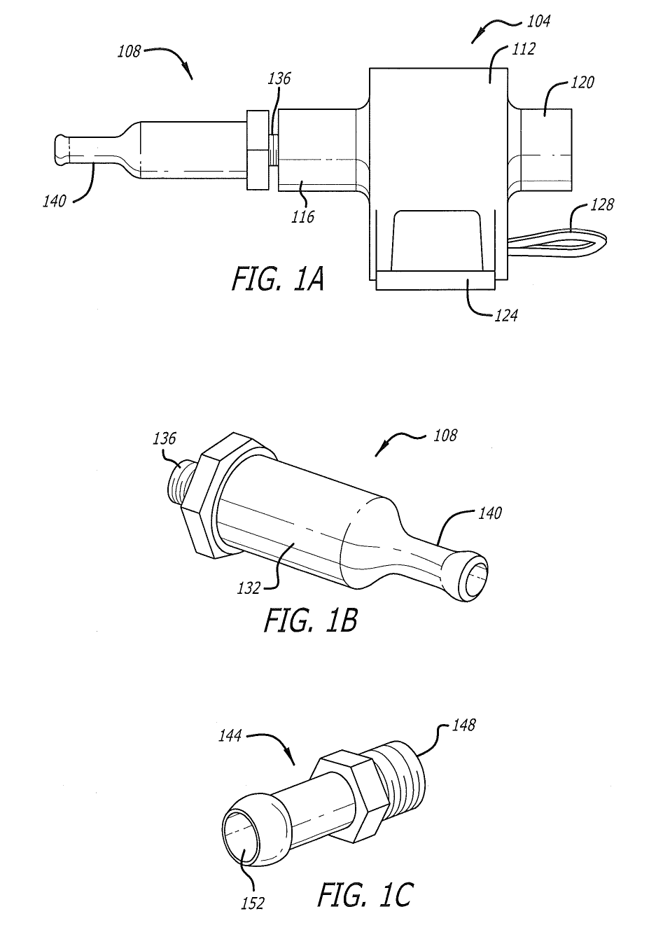

FIG. 1A is a side plan view illustrating an exemplary embodiment of an inline fuel pump 104 coupled with an exemplary fuel filter 108, according to the present disclosure. The inline fuel pump 104 comprises an envelope 112 which houses an electric motor and an internal liquid pump configured to convey liquid fuel from a fuel inlet 116 to a fuel outlet 120. As will be appreciated, the fuel inlet 116 is configured to be placed into fluid communication with a source of liquid fuel, such as a fuel tank of a vehicle, and the fuel outlet 120 is configured to be placed into fluid communication with an intake of an internal combustion engine of the vehicle. Preferably, the intake comprises a fuel bowl of a carburetor, wherein a portion of liquid fuel is temporarily stored before being mixed with intake air for combustion within the engine. The intake is not to be limited to carburetors, however, but rather may be any intake whereby liquid fuel is to be mixed with an airstream for combustion within an internal combustion engine, such as by way of non-limiting example, a throttle body, turbocharger, supercharger, some fuel injection systems, as well as some gas turbines, and the like.

The electric motor and the internal liquid pump preferably are of a combined variety. As will be appreciated, combining the electric motor and the internal liquid pump reduces the weight and overall size of the inline fuel pump 104. In one exemplary embodiment, the inline fuel pump 104 possesses a weight of substantially 18 ounces, and a size of substantially 3 inches. The relatively small size and low weight of the inline fuel pump 104 facilitates installation into a wide variety of suitable locations with the vehicle. The envelope 112 comprises a sealed case which protects the electric motor and the internal liquid pump from an environment exterior of the inlet fuel pump. The envelope 112 further comprises a base 124, which facilitates mounting the inline fuel pump 104 onto any of various flat, horizontal or vertical surfaces within the vehicle. Any of various mechanical fasteners may be used to fasten the base 124 to the flat surface, as needed. It is envisioned that the envelope 112 is comprised of a corrosion resistant composite material that is sufficiently durable and temperature resistant so as to retain its configuration during installation and operation of the inlet fuel pump 104 when coupled with the fuel system of the vehicle.

The internal liquid pump preferably is configured to operate with a wide variety of fuels, such as by way of non-limiting example, gasoline, diesel, biodiesel, gasoline-ethanol blends of up to at least 85% ethanol (E85), as well as various commonly used fuel additives. In some embodiments, the internal liquid pump is of a parachoid rotor variety. In some embodiments, the internal liquid pump may comprise a geocloid rotor. In some embodiments the internal liquid pump may comprise a megafloid rotor. Further, the inline fuel pump 104 may be used on substantially all carburetor equipped engines. In some embodiments, the inline fuel pump 104 may be configured to operate as a lift pump, or a booster pump, for diesel fuel injection systems. It is envisioned, the inline fuel pump 104 maintains fuel pressure between the pump and the diesel injectors when the engine is not operating.

The electric motor preferably is of a brushless motor design, and thus electrical contacts that are subject to operational wear are omitted. In one exemplary embodiment, the inline fuel pump 104 is performance rated for an operation time ranging up to substantially 6,000 hours. Power leads 128 facilitate connecting the inline fuel pump 104 to a source of electrical power, such as an electrical system of a vehicle. Preferably, the electric motor is configured to be powered by way of a 12V vehicle electrical system, although in some embodiments, the electric motor may be powered by way of a 6V or 24V vehicle electrical system. As such, the power leads 128 are provided with different colors so as to differentiate an electrical polarity to which each lead is to be connected. In the embodiment illustrated in FIG. 1A, for example, the power leads 128 comprise a red wire and a black wire. Those skilled in the art will recognize that the red wire is to be connected to a positive 12V electrical source, and the black wire is to be connected to a common ground, such as a chassis of the vehicle.

As mentioned above, the fuel inlet 116 is configured to be placed into fluid communication with the fuel tank of the vehicle, and the fuel outlet 120 is configured to be placed into fluid communication with the intake of the engine. As such, the fuel inlet and the fuel outlet 116, 120 both comprise suitably taper-threaded openings configured to receive any of various fittings suitable for connecting the fuel inlet and the fuel outlet to the fuel system of the vehicle.

In the embodiment illustrated in FIG. 1A, the fuel inlet port 116 is configured to receive the exemplary fuel filter 108. As best shown in FIG. 1B, the exemplary fuel filter 108 is comprised of a rigid envelope 132, a threaded fitting 136, and a hose fitting 140. The fuel filter 108 is generally elongate and comprises a filter medium disposed within the rigid envelope 132. As will be appreciated, the filter medium is comprised of a material suitable for filtering particulate debris and other contaminants from liquid fuel flowing from the hose fitting 140 to the threaded fitting 136. The threaded fitting 136 is configured to be received into the fuel inlet 116, as shown in FIG. 1A. In one exemplary embodiment, the threaded fitting 136 comprises ⅛″ National Pipe Thread Taper (NPT) threads, and the fuel inlet 116 comprises similarly sized threads. It is contemplated that any of various sealants may be applied to the threads to ensure a sealed coupling between the threaded fitting 136 and the fuel inlet 116. The hose fitting 140 comprises a generally smooth, cylindrical surface and is suitably sized to receive a fuel hose which is in fluid communication with the fuel tank of the vehicle. In one exemplary embodiment, the hose fitting 140 is sized to receive a ⅜″ diameter fuel hose. It should be understood, however, that other fuel filters comprising differently-sized hose fittings may be coupled with the inline fuel pump 104 so as to accommodate the fuel systems of various makes and models of vehicles.

FIG. 1C illustrates an exemplary embodiment of a male hose barb 144 which may be coupled with the inline fuel pump 104, as described above. The male hose barb 144 comprises a threaded fitting 148 and a hose fitting 152. The threaded fitting 148 is configured to be threadably received into the fuel outlet 120, and thus the threaded fitting 148 comprises threads that are similarly sized to threads within the fuel outlet 120. In one exemplary embodiment, the threaded fitting 148 and the fuel inlet 116 comprise ⅛″ NPT threads. The hose fitting 152 is substantially similar to the hose fitting 140, illustrated in FIGS. 1A-1B, with the exception that the hose fitting 152 is configured to receive a fuel hose which is in fluid communication with the intake of the vehicle. As such, the hose fitting 152 preferably has a diameter suitable for receiving the fuel hose of the vehicle. In one exemplary embodiment, the hose fitting 152 is sized to receive a ⅜″ diameter fuel hose. As stated above, it should be understood that the inline fuel pump 104 is not limited to being coupled with the fuel filter 108, or the male hose bard 144, but rather the inline fuel pump 104 may be coupled with any of a wide variety of other fittings, including other fuel filters and hose barbs, as disclosed herein, so as to accommodate the fuel systems of various makes and models of vehicles.

During operation of the inline fuel pump 104, the internal liquid pump draws liquid fuel from the fuel tank of the vehicle, by way of the fuel inlet 116, and conveys pressurized liquid fuel to the intake of the vehicle by way of the fuel outlet 120. Those skilled in the art will recognize that various vehicle applications require different degrees of fuel pressure delivered to the intake. The embodiment of the inline fuel pump 104, illustrated in FIG. 1A, generally provides liquid fuel to the intake of the vehicle with a fuel pressure ranging between substantially 1.0 pound per square inch (PSI) and 11.5 PSI. A rate of fuel delivery of the inline fuel pump 104 ranges between substantially 15 gallons per hour (GPH) and 34 GPH. In one exemplary embodiment, however, the inline fuel pump 104 delivers substantially 15 GPH at a pressure ranging between substantially 1.0 PSI and 2.0 PSI, which is suitable for small engine applications, such as by way of non-limiting example, generators, power equipment, motorcycles, ATVs, and the like. In another exemplary embodiment, the inline fuel pump 104 delivers substantially 25 GPH at a pressure ranging between substantially 1.5 PSI and 4.0 PSI, which is well suited for use with carbureted four-cylinder and six-cylinder automotive applications. In another exemplary embodiment, the inline fuel pump 104 delivers substantially 32 GPH at a fuel pressure ranging from substantially 4.0 PSI to substantially 7.0 PSI, and thus is ideal for typical gasoline-powered eight-cylinder car and truck applications. In still another exemplary embodiment, the inline fuel pump 104 delivers substantially 34 GPH at a fuel pressure ranging between substantially 9.0 PSI and 11.5 PSI. As will be apparent to those skilled in the art, the latter exemplary embodiment is particularly well-suited for diesel applications due to higher fuel pressure requirements of diesel engines. Further, it is envisioned that an internal check valve may be incorporated into the inline fuel pump 104 so as to maintain the pressure within the fuel system when the engine is powered off. Those skilled in the art will recognize that maintaining fuel pressure within the fuel system is particularly critical in diesel and power-sports applications.

Just as fuel delivery at a proper pressure is critical, an ability of the inline fuel pump 104 to draw fuel out of the fuel take also must be considered. For example, in some applications, wherein fuel is not gravity fed to the fuel pump, the pump must be capable of creating a degree of suction suitable for pulling the fuel out of the tank, through the fuel hose, and then directing the fuel to the internal liquid pump. Moreover, in some applications it may be necessary to install the fuel pump at a certain height above the fuel tank, thereby increasing the degree of suction required to draw the fuel out of the fuel tank. In the embodiment illustrated in FIG. 1A, the inline fuel pump 104 is configured to be positioned at a height above the fuel tank ranging up to substantially 50 inches. In one exemplary embodiment, however, wherein the inline fuel pump 104 is configured to deliver between 25 GPH and 32 GPH of fuel, the inline fuel pump is configured to be positioned at a height above the fuel tank ranging up to substantially 12 inches. In another exemplary embodiment, wherein the inline fuel pump 104 is configured to deliver 15 GPH of fuel and may be positioned at a height ranging up to substantially 24 inches above the fuel tank, In still another exemplary embodiment, the inline fuel pump 104 is configured to delivery 34 GPH of fuel and may be positioned at a height ranging up to substantially 50 inches above the fuel tank. The latter embodiment is particularly well suited for use with diesel fuel systems in which higher fuel pressures are critical.

As will be appreciated, due to the ability of the inline fuel pump 104 to create a suction at the fuel inlet 116, the inline fuel pump is advantageously self-priming. Thus, if air enters the fuel system, such as during replacing the fuel filter 108 or when the fuel tank runs empty, a user of the inline fuel pump 104 need not intentionally feed liquid fuel into the fuel inlet 116 so as to facilitate operation of the inline fuel pump. Further, as described above, the inline fuel pump 104 delivers fuel at specific fuel pressures, as well as maintaining the fuel pressure when the engine is not operating, and thus the inline fuel pump 104 eliminates any need for including a separate fuel pressure regulator within the fuel system. Moreover, those skilled in the art will appreciate that the degree of fuel pressure achievable with the inline fuel pump 104, coupled with a lack of exposure to high engine temperatures substantially eliminates occurrences of vapor lock and engine flooding.

It should be recognized that the exemplary fuel filter 108 generally is disposable, wherein the fuel filter 108 is used until the filter medium becomes dirty or clogged and then the fuel filter 108 is removed from the vehicle and discarded, and a new fuel filter is then installed. In some instances, however, it will be advantageous to couple the inline fuel pump 104 with a reusable fuel filter wherein a dirty or clogged filter medium may be removed from the fuel system, cleaned, and then reinstalled into the fuel system.

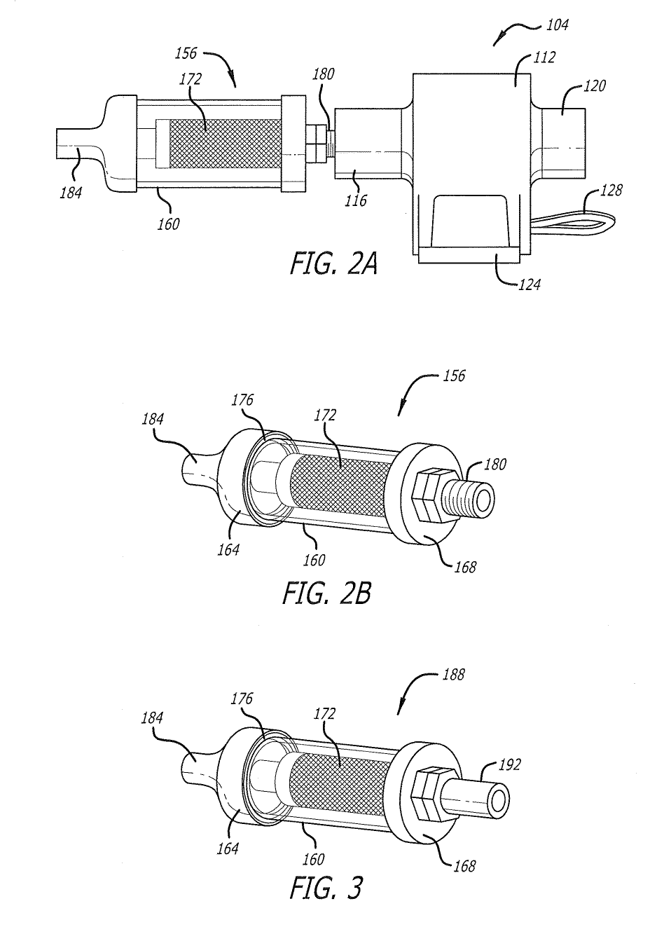

FIG. 2A illustrates an exemplary embodiment of a reusable fuel filter 156 coupled to the fuel inlet 116 of the inline fuel pump 104, according to the present disclosure. As best shown in FIG. 2B, the reusable fuel filter 156 is comprised of a glass cylinder 160 coupled between a first end cap 164 and a second end cap 168. The glass cylinder 160 facilitates directly viewing particulate debris and other contaminants that are trapped by a filter medium 172 within the reusable fuel filter 156 so as to determine when cleaning the filter medium is necessary. The filter medium 172 generally is comprised of a material suitable for filtering particulate debris and other contaminants from liquid fuel flowing through the fuel filter 156 so as to deliver clean fuel to the inline fuel pump 104.

The first and second end caps 164, 168 preferably are fastened together such that a fluid-tight seal is formed between the end caps and the glass cylinder 160. In some embodiments, an elongate member may be disposed within the glass cylinder 160 and threadably receive the first and second end caps 164, 168 on opposite ends of the elongate member, such that the glass cylinder 160 is sealed between the end caps. In some embodiments, the elongate member may be a protrusion of one of the first and second end caps 164, 168, and the other of the end caps may be threadably received onto the elongate member so as to seal the glass cylinder 160 between the end caps. Further, each of the first and second end caps 164, 168 comprises a recessed seal 176 configured to receive and seal a circumferential edge of the glass cylinder 160, thereby forming an interior chamber of the fuel filter which houses the filter medium 172, as shown in FIG. 2B.

As shown in FIGS. 2A and 2B, the reusable fuel filter 156 comprises a threaded fitting 180 and a hose fitting 184 disposed at opposite ends of the fuel filter. In the embodiment illustrated in FIG. 2B, the threaded fitting 180 protrudes longitudinally from the second end cap 168 and is configured to be received into the fuel inlet 116, as shown in FIG. 2A. In one exemplary embodiment, the threaded fitting 180 comprises ⅛″ NPT threads, and the fuel inlet 116 comprises similarly sized threads, as discussed in connection with FIGS. 1A and 1B. The hose fitting 184 extends longitudinally from the first end cap 164 in a direction opposite to the threaded fitting 180. Similarly to the hose fitting 140, discussed with reference to FIG. 1C, the hose fitting 184 comprises a generally smooth, cylindrical surface and is suitably sized to receive a fuel hose which is in fluid communication with the fuel tank of the vehicle. In one exemplary embodiment, the hose fitting 184 is sized to receive a ⅜″ diameter fuel hose. It is contemplated, however, that differently-sized fittings than shown in FIG. 2A-2B may be coupled with the reusable fuel filter 156 and the inline fuel pump 104 so as to accommodate a wide variety of fuel system applications encountered with various makes and models of vehicles.

As will be appreciated, the filter medium 172 is disposed within the fuel filter 156 such that an interior of the fuel filter 156 is subdivided into at least two chambers. The hose fitting 184 generally is in fluid communication with a first chamber, and the threaded fitting 180 is in fluid communication with a second chamber. Thus, when the fuel filter 156 is coupled with the inline fuel pump 104, as shown in FIG. 2A, and the pump is operating, liquid fuel is drawn from the fuel tank into the first chamber by way of the hose fitting 184. The fuel is drawn from the first chamber through the filter medium 172 wherein any particulate debris and other contaminants flowing with the fuel are entrapped by the filter medium 172, and then the fuel enters the second chamber of the fuel filter 156. The fuel then exits the second chamber by way of the threaded fitting 180 and enters the fuel inlet 116. Positioning the fuel filter 156 upstream of the inline fuel pump 104, as shown in FIG. 2A, ensures that fuel entering the inline fuel pump 104 has been cleaned of any particulates that may otherwise damage the pump.

It is contemplated that a user of the reusable fuel filter 156 may occasionally clean the filter medium 172, rather than discarding the fuel filter and installing a new fuel filter as is commonly done with disposable filters. As described above, the user may peer through the glass cylinder 160 to directly observer a buildup of particulate entrapped by the filter medium 172. If the buildup is deemed to be excessive, the user may remove the fuel hose from the hose fitting 184, and then remove the fuel filter 156 from the vehicle by unscrewing the threaded fitting 180 from the fuel inlet 116 of the inline fuel pump 104. With the fuel filter 156 removed from the vehicle, the first and second end caps 164, 168 may be unscrewed to release the glass cylinder 160 and gain access to the filter medium 172. It is contemplated that any of various suitable solvents may be utilized to remove the buildup of particulate from the filter medium 172. Once clean, the filter medium 172 may be reinstalled within the glass cylinder 160 and the end caps 164, 168. In some embodiments, the user may apply any of various sealants to the threads of the threaded fitting 180 so as to ensure a sealed coupling between the threaded fitting 180 and the fuel inlet 116. The fuel filter 156 may be installed into the vehicle by screwing the threaded fitting 180 into the fuel inlet 116. It is contemplated that a manufacturer recommended degree of torque may be applied to the threaded fitting 180, and then the fuel hose may be inserted onto the hose fitting 184. Upon applying electrical power to the inline fuel pump 104, such as by way of an ignition switch of the vehicle, fuel is drawn from the fuel tank through the fuel filter 156 into the inline fuel pump 104 and then conveyed to the intake of the vehicle. As described herein, the user need not prime the inline fuel pump 104 in an attempt to remove air from the fuel system.

As will be recognized by those skilled in the art, there may be certain automotive applications wherein directly coupling the fuel filter 156 and the inline fuel pump 104 is impracticable. For example, nearby structures or components within the vehicle may obstruct the fuel filter 156, or the fuel filter 156 may be placed into a position which prohibits directly viewing the state of the filter medium 172 within the fuel filter. It is contemplated that in such applications, the inline fuel pump 104 may be advantageously used in conjunction with a reusable inline fuel filter 188, as shown in FIG. 3. The reusable inline fuel filter 188 is substantially similar to the reusable fuel filter 156, illustrated in FIG. 2B, with the exception that the reusable inline fuel filter 188 comprises a downstream hose fitting 192 in lieu of the threaded fitting 180. The downstream hose fitting 192 is substantially similar to the hose fitting 184, and thus the downstream hose fitting 192 comprises a generally smooth, cylindrical surface suitable for receiving a fuel hose of the vehicle. In one exemplary embodiment, the downstream hose fitting 192 is sized to receive a ⅜″ diameter fuel hose, although various other diameters of the downstream hose fitting are contemplated.

Installation of the reusable inline fuel filter 188 is substantially similar to the installation of the fuel filter 156, with the exception that the reusable fuel filter 188 is installed upstream of, but not directly coupled to the inline fuel pump 104. As such, a fuel hose may be installed between the downstream hose fitting 192 and the fuel inlet 116 by way of a male hose barb which is substantially similar to the male hose bard 144, illustrated in FIG. 1C. Thus, a first male hose barb 144 may be installed into the fuel inlet 116, and a second male hose barb 144 may be installed into the fuel outlet 120 as described above. It is contemplated, therefore, that any of various thread sealants may be applied to the threaded fitting 148, and then the first male hose barb 144 may be screwed into the fuel inlet 116 with a manufacturer recommended degree of torque. With the reusable inline fuel filter 188 installed upstream of the inline fuel pump 104, a suitable length of fuel hose may be routed from the downstream hose fitting 192 and then pushed suitably onto the hose fitting 152 at the fuel inlet 116. Upon suitably installing the fuel hose of the vehicle onto the second male hose barb 144 at the fuel outlet 120, the inline fuel pump 104 may be electrically powered to convey fuel from the fuel tank to the intake of the vehicle.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

1. An inline fuel pump for conveying liquid fuel from a fuel source to an intake of an internal combustion engine, comprising:
an inlet configured to be placed into fluid communication with the fuel source;
an outlet configured to be placed into fluid communication with the intake;
an electric motor coupled with an internal liquid pump configured to convey liquid fuel from the inlet to the outlet;
an envelope which houses the electric motor and the internal liquid pump; and
at least two power leads configured to convey electrical power to the electric motor.

2. The inline fuel pump of claim 1, wherein the electric motor is brushless and combined with the internal liquid pump, the electric motor being configured to be powered by way of a 6V, 12V, or 24V vehicle electrical system.

3. The inline fuel pump of claim 1, wherein the envelope comprises a sealed case configured to protect the electric motor and the internal liquid pump from an exterior environment.

4. The inline fuel pump of claim 3, wherein the envelope comprises a base configured for mounting the inline fuel pump onto a flat surface within the vehicle by way of mechanical fasteners.

5. The inline fuel pump of claim 3, wherein the envelope is comprised of a corrosion resistant composite material that is sufficiently durable and temperature resistant to retain its configuration during installation and operation of the inlet fuel pump when coupled with the fuel system of the vehicle.

6. The inline fuel pump of claim 1, wherein the internal liquid pump is configured to operate with various fuels, such as gasoline, diesel, biodiesel, gasoline-ethanol blends of up to at least 85% ethanol (E85), as well as one or more commonly used fuel additives.

7. The inline fuel pump of claim 1, wherein the inlet and the outlet both comprise suitably taper-threaded openings configured to receive any of various fittings suitable for connecting the inlet and the outlet to a fuel system of a vehicle.

8. The inline fuel pump of claim 1, wherein the inlet is configured to receive a fuel filter comprising a filter medium disposed within a rigid envelope, a threaded fitting configured to be received into the inlet, and a hose fitting configured to receive a fuel hose which is in fluid communication with the fuel source.

9. The inline fuel pump of claim 8, wherein the filter medium is comprised of a material suitable for filtering particulate debris and contaminants from liquid fuel flowing from the hose fitting to the threaded fitting.

10. The inline fuel pump of claim 1, wherein the inlet is configured to receive a reusable fuel filter comprising a filter medium within a glass cylinder which is sealed between a first end cap and a second end cap.

11. The inline fuel pump of claim 10, wherein the glass cylinder is configured to facilitate directly viewing particulate debris and contaminants that are entrapped by the filter medium.

12. The inline fuel pump of claim 10, wherein the filter medium is comprised of a material suitable for filtering particulate debris and other contaminants from liquid fuel.

13. The inline fuel pump of claim 10, wherein a threaded fitting longitudinally protrudes from the second end cap and is configured to be received into the inlet, and a hose fitting extending longitudinally from the first end cap is configured to receive a fuel hose in fluid communication with the fuel source.

14. The inline fuel pump of claim 10, wherein a downstream hose fitting protrudes from the second end cap and is configured to receive a fuel hose.

15. A method for cleaning a reusable fuel filter comprising a filter medium within a glass cylinder which is sealed between a first end cap and a second end cap, comprising:
removing a fuel hose from the first end cap;
unscrewing the reusable fuel filter from an inlet of an inline fuel pump;
gaining access to the filter medium by unscrewing the first end cap and the second end cap to release the glass cylinder from the reusable fuel filter;
utilizing a solvent to remove a buildup of particulate from the filter medium;
reinstalling the filter medium within the glass cylinder;
tightening the first end cap and the second end cap so as to seal the filter medium within the reusable fuel filter;
establishing fluid communication between the second end cap and the inlet of the inline fuel pump; and
inserting the fuel hose onto the first end cap.

16. The method of claim 15, wherein inserting the fuel hose comprises pushing the fuel hose onto a hose fitting of the first end cap, the fuel hose routing liquid fuel from a fuel source to the reusable fuel filter.

17. The method of claim 15, wherein establishing fluid communication comprises screwing a threaded fitting of the second end cap into the inlet of the inline fuel pump.

18. The method of claim 17, wherein installing further comprises applying any of various sealants to the threads of the threaded fitting.

19. The method of claim 15, wherein establishing fluid communication comprises screwing a threaded fitting of a male hose barb into the inlet of the inline fuel pump, inserting a first end of a fuel hose onto the male hose barb, and inserting a second end of the fuel hose onto a hose fitting of the second end cap.
